(19) United States
(12) Patent Application Publication
(10) Pub. No.: US 2016/0239230 A1
(43) Pub. Date: Aug. 18, 2016

(54) STORAGE SYSTEM AND METHOD FOR CONTROLLING STORAGE SYSTEM

(71) Applicant: HITACHI, LTD., Tokyo (JP)

(72) Inventors: Nakaba SATO, Tokyo (JP); Jun KITAHARA, Tokyo (JP)

(73) Assignee: HITACHI, LTD., Tokyo (JP)

(21) Appl. No.: 14/346,210

(22) PCT Filed: Aug. 28, 2013
(86) PCT No.: PCT/JP2013/072958

§ 371 Date: Mar. 20, 2014

(51) Int. Cl. G06F 3/06; H04L 12/26; H04L 29/08; H04L 29/06; H04L 29/12

(52) U.S. Cl. CPC G06F 3/0622; G06F 3/0653; G06F 3/0689; G06F 3/067; H04L 63/10; H04L 61/2007; H04L 67/1097; H04L 43/08

(57) ABSTRACT

The present invention provides a storage system 1 comprising a host interface for receiving I/O requests from a host via a SAN, and a management interface for receiving network packets from a management terminal or other devices within a management network. The storage system analyzes the characteristics of I/O requests from the host, and changes a filter level based on the characteristics of the I/O requests. Further, the storage system executes control to increase the number of types of network packets to be abandoned out of the network packets arriving at the management interface when the filter level is high, and to reduce the number of types of network packets to be abandoned when the filter level is low, so as to prevent the processing of network packets arriving at the management interface from affecting the I/O performance of the host.

### TECHNICAL FIELD

The present invention relates to a storage device having an interface for receiving a normal host I/O and an interface for receiving a storage management request, and a method for maintaining the processing performance of the storage device.

### BACKGROUND ART

Along with the advancement of IT and the spreading of the Internet, the amount of data handled through computer systems in companies and the like is increasing continuously. Therefore, in many computer systems, a storage system capable of saving a large capacity of data is provided in addition to a built-in storage device of the host computer, and data is stored and managed within the storage system. A large-capacity storage system is provided with a large number of storage devices arranged in arrays, and storage resources configured as RAIDs (Redundant Arrays of Inexpensive (or Independent) Disks) are provided to the host computer. The host computer and the storage system are connected mutually via a devise-sharing network such as a SAN (Storage Area Network).

Further, the storage system is connected via the SAN to the host computer and also connected via a management network to a management computer for managing the storage system. The storage system performs processing of data I/O requests from the host computer and also performs processing based on management requests from the management computer arriving via the management network.

Recently, security measures are one of the most important issues in computer systems. In many computer systems, enhanced security measures must be provided to various devices connected to the network, and many devices and host computers are provided with a so-called filtering (packet filtering) function of analyzing the contents of packets arriving via the network, detecting packets that do not correspond to given conditions (abnormal packets), and abandoning such packets without receiving or passing the packets. For example, Patent Literature 1 discloses a policy-based intrusion prevention system for monitoring data transmitted via the network, detecting illegal access, storing the data pattern causing an illegal operation and creating a protection policy based on the storage information. In addition, as measures for strengthening the security of the whole computer system, the operation of performing a vulnerability scan for periodically checking vulnerability of security of respective devices connected to the network is increasing. Since the storage system is connected to the management network within the computer system for operation, the storage system is also set as the target of vulnerability scan, similar to the various devices connected to the network.

### CITATION LIST

### Patent Literature

### [PTL 1]

Japanese Patent No. 4412489

### SUMMARY OF INVENTION

### Technical Problem

Processes such as unauthorized access detection and prevention of instruction from the network taught in patent literature 1 are processes causing a high load, and may possibly inhibit processes and operations that the respective devices must perform. In the case of storage systems, the processing of I/O requests arriving from one or multiple host computers is the main operation, but it is required that the storage systems perform in a stable manner. Especially when the operation performed in the host computer is an important operation, not even a temporal deterioration of I/O processing performance is unaccepted, and not much time can be spared to perform processes other than the processing of the I/O requests as the main operation of the storage systems.

Similarly, when a vulnerability scan is performed in the storage system, the processing of network packets for the vulnerability scan must be performed in parallel with the I/O processing, but since a large amount of packets arrive at the storage system in a vulnerability scan, it has a large influence on the I/O processing. If the storage system is excluded from the target of the vulnerability scan performed in the computer system, it becomes possible to prevent deterioration of I/O performance of the storage system, but the security operation policy of the computer system will be varied and the security of the whole system cannot be ensured, so that it is not a preferable operation. The object of the present invention is to provide a storage system that enables to maintain the I/O performance and ensure security at the same time, which are conflicting requirements.

### Solution to Problem

In order to solve the above problems, the present invention provides a storage system including a processor, one or more volumes, a host interface for receiving I/O requests issued from the host computer to the volume, and a management interface for connecting to the management network, the storage system equipped with a function for monitoring and analyzing an access characteristics of the host computer to the volume, and a filtering function of a given type of packets out of the network packets arriving to the management network from the external devices. The storage system also has a means for dynamically increasing or decreasing the number of types of network packets to be abandoned based on an access tendency to the volume.

According to the filtering function of the present storage system, the types of packets to be filtered vary according to the filter level. The filtering function analyzes the contents of the arriving network packets, and filters one or more types of packets selected from a vulnerability scan access packet, an attack access packet, an encrypted access packet, and a plaintext access packet. When the filter level is set to 0, filtering of packets will not be performed, but as the filter level increases, the number of types of packets to be filtered increases.

The filter level is determined by the processor of the storage system based on the access tendency to the volume derived from the analyzing function of the access characteristics. The analyzing function of the access characteristics analyzes an I/O (access) load average, an I/O load variability and an I/O load pattern, and when the I/O load average and/or the I/O load variability is high, or when the I/O load pattern corresponds to a specific pattern, increases the filter level of the filtering function, and the filtering function increases the number of types of packets to be filtered.

### Advantageous Effects of Invention

According to the storage system of the present invention, when the load of I/O processing is high, the number of types of packets to be blocked temporarily out of the multiple types of data packets arriving from the network is increased, so as not to inhibit the I/O processing. Further, when the I/O processing load of the storage system is reduced, the number of the types of packets to be blocked can be reduced so as to enable reception of vulnerability scan accesses and other security checks executed within the computer system, so that the present storage system can maintain the I/O performance of the storage system and ensure security at the same time.

### BRIEF DESCRIPTION OF DRAWINGS

FIG. 1 is a configuration diagram illustrating a computer system and a storage system according to a preferred embodiment of the present invention.

FIG. 2 is a view showing the data stored in a RAM 113 in the storage system 1.

FIG. 3 is a view showing one example of the relationship between the filter level and the types of network packets to be abandoned.

FIG. 4 is a view showing the contents of a filter level information 1200.

FIG. 5 is a view showing the contents of a precursor IP list 1102.

FIG. 6 is a view showing the contents of a block IP list 1101.

FIG. 7 is a view showing the contents of a static rule list 1104.

FIG. 8 is a flowchart showing a process executed by a filter level user setting program 1003.

FIG. 9 is a flowchart of processes for changing the filter level by the I/O access pattern analyzing program 1004.

FIG. 10 is a view showing a relationship between the host operation and the I/O access tendency to the storage system.

FIG. 11 shows the contents of an I/O pattern list 1103.

FIG. 12 is a flowchart of the process executed by a filter level management program 1005.

FIG. 13 is a view showing a relationship between a packet reception program 1006, a network API section 1008 and the like.

FIG. 14 is a flowchart of the process executed by a precursor packet reception module 10061.

FIG. 15 is a flowchart of the process executed by a data check module 10081.

FIG. 16 is a flowchart of a process (former half) executed by a packet filter module 10062.

FIG. 17 is a flowchart of a process (latter half) executed by the packet filter module 10062.

FIG. 18 is a flowchart of a process executed by an IP block cancellation program 1009.

### DESCRIPTION OF EMBODIMENTS

Now, a storage system (storage device) according to a preferred embodiment of the present invention will be described with reference to the drawings. The present invention is not restricted to the preferred embodiments described hereafter.

### Preferred Embodiments

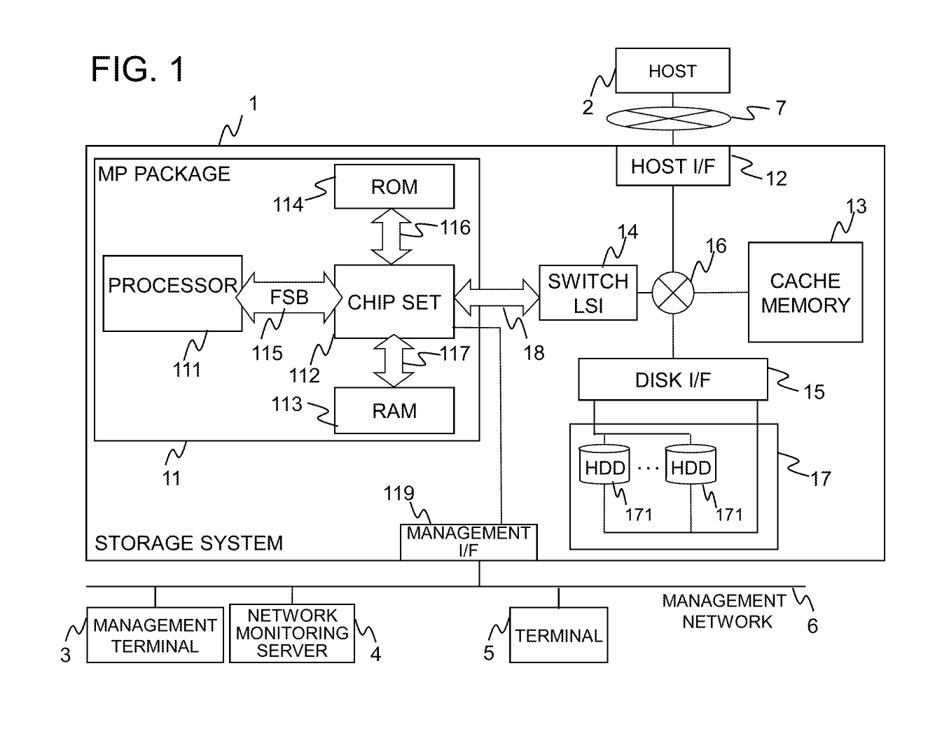

FIG. 1 shows a configuration of a storage system 1 (also referred to as a storage device, hereinafter described as “storage system 1”) according to a preferred embodiment of the present invention, and a configuration of a computer system in which the storage system 1 is used. The computer system according to the preferred embodiment of the present invention is composed of a storage system 1, one or more host computers 2 (hereinafter abbreviated as “host 2”), a storage management terminal 3 (hereinafter abbreviated as “management terminal 3”), a network monitoring server 4, and other groups of terminals 5. The storage system 1 is coupled to the host 2 via a SAN (Storage Area Network) 7, and also coupled to the management terminal 3, the network monitoring server 4 or the other groups of terminals 5 via a management network 6. The management terminal 3 is a terminal for carrying out a management operation of the storage system 1, which actually involves a well-known management operation such as defining volumes used by the hosts 2, and monitoring performance information or failure information of the storage system. In the present embodiment, the network monitoring server 4 is a server for carrying out a vulnerability scan of the devices such as storage system 1 and the group of terminals 5 coupled to the management network 6. The SAN 7 is a network used for transmitting access requests (I/O requests) or read/write data when the host 2 accesses (reads or writes) the data stored in a storage area (volume) within the storage system 1, and Fibre Channel or Ethernet (Registered Trademark), for example, is used as its physical media.

The management network 6 is a network used, for example, by the management terminal 3 to perform management operations such as creation of volume or monitoring of failure of the storage system 1, or by the network monitoring server 4 to perform operations such as a vulnerability scan of the storage system 1 or other devices, wherein physical media such as the Ethernet is used.

Next, we will describe the components of the storage system 1. The storage system 1 has an MP (Micro Processor) package 1, a host interface (host I/F) 12, a cache memory 13, a switch LSI (Large Scale Integration) 14, a disk interface (disk I/F) 15, an internal network 16, a disk array unit 17, and a management interface (management I/F) 119. A configuration can be adopted in which pluralities of each of the components described above are disposed within the storage system 1.

The host I/F 12, the cache memory 13, the switch LSI 14 and the disk I/F 15 are mutually connected via an internal network 16. Further, the switch LSI 14 is coupled to the MP package 1 via an address/data signal line 18.

The disk array unit 17 has multiple HDDs (Hard Disk Drives) 171, and each HDD 171 is coupled to the disk I/F 15. The storage system 1 composes a RAID (Redundant Arrays of Independent (or Inexpensive) Disks) group using two or more HDDs out of the multiple HDDs 171, and based on the composed RAID group, creates one or more logical volumes (storage areas). It has a function to provide logical volumes to the hosts 2 (which enables the hosts 2 to recognize the logical volumes and access the same) so that the hosts 2 can access (read/write data from/to) the logical volumes via the SAN 7. The function of composing a RAID group of multiple HDDs 171, and forming one or more logical volumes from the RAID groups and providing the same to the hosts 2 is similar to the function provided in a well-known storage device, so that detailed description of these functions are omitted from the present specification. Further, various types of physical storage devices, such as SSD (Solid State Drive) which is a storage device using a flash memory, can be adopted instead of the HDD 171.

The host I/F 12 is an interface for coupling the storage system 1 to the SAN 7, wherein if Fibre Channel is used as the physical media of SAN 7, the host I/F 12 is a Fibre Channel interface, and if Ethernet is used as the physical media of SAN 7, the host I/F 12 is an Ethernet interface. The storage system 1 receives I/O requests (such as file-level or block-level I/O requests) from the host 2 via the host I/F 12, and transfers the received I/O requests via the internal network 16, the switch LSI 14 and the address/data signal line 18 to an MP package 11. Further, when the host I/F 12 receives from the MP package 11 the processing result of the I/O request received from the host 2, a response including the processing result is sent to the host 2.

A management I/F 119 is an interface for coupling the storage system 1 to the management network 6, and in the present embodiment, an Ethernet interface is used. The storage system 1 receives management operations such as creation of volume or monitoring of performance from the management terminal 3 coupled to the management network 6.

The cache memory 13 is for temporarily storing data accompanying a write request from a host 2 (write target data) or data read out from a group of HDDs 171 based on a read request from the host 2 (read target data).

The switch LSI 14 is an LSI for controlling the communication between the MP package 1, the host I/F 12, the cache memory 13 and the disk I/F 15.

The MP package 11 includes a processor 111, a chip set 112, a RAM (Random Access Memory) 113 which is a storage resource, and a ROM (Read Only Memory) 114. The processor 111 is coupled to the chip set 112 via a front side bus (FSB) 115. The RAM 113 and the ROM 114 are respectively coupled to the chip set 112 via a bus 117 and a bus 116.

The chip set 112 is one or multiple LSIs for managing the transmission and reception of data among the processor 111, the RAM 113 and the ROM 114.

The ROM 114 is a rewritable nonvolatile memory such as a flash memory, and stores multiple computer programs (hereinafter abbreviated as “programs”) executed by the processor 111. However, it is possible to use a non-rewritable nonvolatile memory instead of the flash memory as the ROM 114.

The RAM 113 is used for storing programs and various control information when the processor 111 executes programs. When the storage system 1 is started, various programs are read from the ROM 114 and stored in the RAM 113.

Next, we will describe the processing of various programs executed by the storage system 1 according to a preferred embodiment of the present invention. In the storage system 1 according to the preferred embodiment of the present invention, the processor 111 executes in parallel the processing of the I/O request received from the host 2 coupled thereto via the SAN 7 (hereinafter referred to as “I/O task”) and the processing of a storage management operation request received from the management terminal 3 or the like coupled thereto via the management network 6 (hereinafter referred to as “management task”). The description “executes in parallel” means that the I/O task and the management task are substantially executed simultaneously for example by alternately executing the I/O task and the management task within a short time via a processing method such as multitasking. Therefore, when a large number of management tasks are executed, such as when the management terminal 3 frequently receives a performance monitoring request or the like of the storage system 1, the frequency and time required for executing the management task in the processor 111 is increased, so that the time for executing the I/O task in the processor 111 is reduced, that is, the I/O performance may be deteriorated. Further according to recent computer systems, ensuring of security is considered important, and there are cases where a so-called vulnerability test is executed to the various devices within the computer system so as to check whether they have tolerance against unauthorized access via the network from outside malicious attackers and the like. Since the storage system 1 is one of the target devices of the vulnerability test, there are cases where a large number of network packets for the vulnerability test arrive at the storage system 1. If such network packets arrive at the storage system 1, it is necessary to execute a process for checking the contents of the respective network packets (checking, for example, whether the request is a management operation request, whether the packet is a unauthorized network packet, or what type of management operation request has been received), so that if a large number of network packets for the vulnerability test arrive, the processor 111 must spare much time to check the contents of the network packets, so that the execution ratio of the I/O task is deteriorated. Though the management task or the vulnerability test is not a process executed constantly at a high frequency, the execution ratio of the I/O task is deteriorated during execution of these processes, so that the I/O performance is deteriorated. Depending on the type of the operation executed by the host 2, there are cases where even a temporary deterioration of I/O performance is unacceptable. Therefore, during the time when an operation that cannot accept deterioration of I/O performance is executed in the host 2, it is necessary to temporarily restrict the reception of requests of management tasks and vulnerability tests (hereinafter referred to as “network accesses”) so as to prevent the I/O performance from being affected. The storage system 1 according to one preferred embodiment of the present invention has programs for analyzing the tendency of the I/O processes received from the hosts 2, and based on the I/O processing tendency, temporarily restricting (filtering) the reception of network accesses to prevent deterioration of the I/O processing performance, wherein the following describes the details of the respective programs.

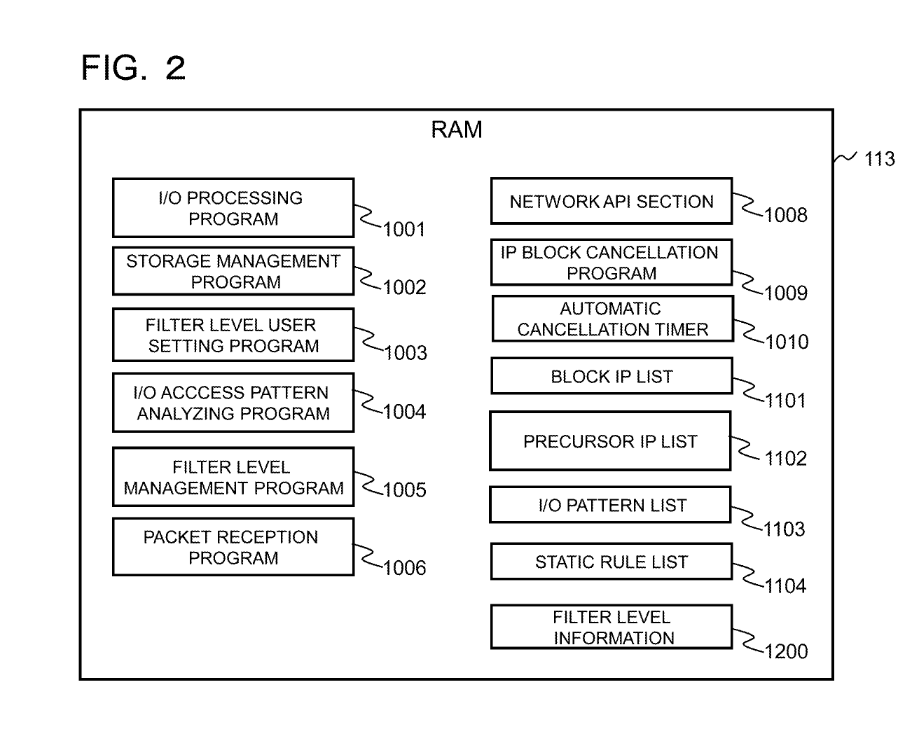

FIG. 2 shows the contents of data and programs stored in the RAM 113 of the storage system 1. The RAM 113 stores an I/O processing program 1001, a storage management program 1002, a filter level user setting program 1003, an I/O access pattern analyzing program 1004, a filter level management program 1005, a packet reception program 1006, a network API section 1008, an IP block cancellation program 1009, and a program for an automatic cancellation timer 1010. Further, as the control information used during execution of these programs, a block IP list 1101, a precursor IP list 1102, an I/O pattern list 1103, a static rule list 1104, and a filter level information 12000 are stored in the RAM 113.

The I/O processing program 1001 is a program for receiving the read request or the write request (commands) from the host 2 to the volume, and executing the reading and writing of data (data I/O) to the cache memory 13 or the HDD 171. The function for performing data I/O processing is equipped in a normal well-known storage system, so that in the present specification, the functions and processes realized by the I/O processing program 1001 will be omitted. Further, the I/O processing program 1001 has a function for monitoring I/O load from the host 2 (called a load monitoring function) simultaneously as processing the reading and writing of data, and the contents of the load monitoring function will be described later.

The storage management program 1002 is a program for receiving a storage management operation request from the management terminal 3 and executing processing (management task) in response to the request. The storage management program 1002 according to the present embodiment provides a so-called WWW-based GUI to the management terminal 3, wherein the storage management program 1002 includes a WWW server program, and on the other hand, the management terminal 3 includes a Web browser program. Therefore, the communication between the storage management program 1002 and the management terminal 3 performs communication according to an HTTP (Hypertext Transfer Protocol) or an HTTPS (Hypertext Transfer Protocol Secure, so-called SSL (Secure Sockets Layer) protocol). However, as another form of embodiment, the storage management program 1002 can provide a GUI that is not WWW-based, or the program can provide a CLI (Command Line Interface). The administrator of storage system 1 uses the Web browser of the management terminal 3, and outputs a management operation request to the storage system 1. The content of the management task performed by the storage management program 1002 is similar to that performed in a well-known storage system, so that in the present specification, the description of the actual processing of the management task will be omitted.

In the storage system 1, the programs for realizing a function to temporarily restrict (filter) the reception of requests (network access) of management tasks and vulnerability tests are the filter level user setting program 1003, the I/O access pattern analyzing program 1004, the filter level management program 1005, the packet reception program 1006, and the network API section 1008. In these programs, the filter level user setting program 1003, the I/O access pattern analyzing program 1004 and the filter level management program 1005 are programs for changing the level for restricting the reception of the network access according to the tendency of I/O requests that the storage system 1 receives from the hosts 2. The packet reception program 1006 and the network API section 1008 are programs for determining whether the network packet reaching the management I/F 119 is an abnormal packet or not, and abandoning (filtering) the packet corresponding to a given condition, in other words, these programs actually perform a process to restrict network accesses. The IP block cancellation program 1009 and the automatic cancellation timer 1010 are programs related to the process for cancelling the restriction of network access. In the present specification, there are descriptions describing that a program acts as the subject of the operation to perform a specific process, such as “the program . . . executes the process”, but it means that the hardware section of the computer executing a program, such as the processor 111, executes a program to realize the processes or the functions described in the present specification.

At first, before describing the contents of these programs, we will describe the outline of the packet filtering process according to the present embodiment. In general, packet filtering refers to a function of analyzing the contents of packets arriving via the network, and abandoning packets (abnormal packets) that correspond (or do not correspond) to a given condition. The packet filtering process according to the storage system 1 of the present invention is a similar process. The storage management program 1002 or other programs communicating with an external device such as the management terminal 3 via the management network confirm the content of a packet via a packet filtering function (realized by the programs) prior to receiving a network packet arriving at the storage system 1 via the management network and carrying out the processing, and as a result of the confirmation, packets corresponding to a given condition are abandoned and will not be handed over to the storage management program 1002 or the like. Further, the storage system 1 according to the present invention defines a value referred to as “filter level”, wherein if the filter level is high, the types of network packets being abandoned (filtered) out of the network packets arriving at the management I/F 119 are increased, and if the filter level is low, the type of network packets being abandoned (filtered) are reduced. The filter level value is determined by the storage system 1 based on the tendency of I/O requests received from the host 2. Specifically, the tendency of the I/O requests is analyzed, and if it is determined that the I/O load is high and that the processor 111 has little available capacity to perform operations other than the I/O processing (corresponding to the processing of the packets received from the management network), and/or if it is determined that the host 2 is carrying out an operation where I/O performance must not be deteriorated, an operation to increase the filter level is performed, and if not, an operation to reduce the filter level is performed, so that the processing of the network packets or the management task does not have a harmful effect on the I/O processing.

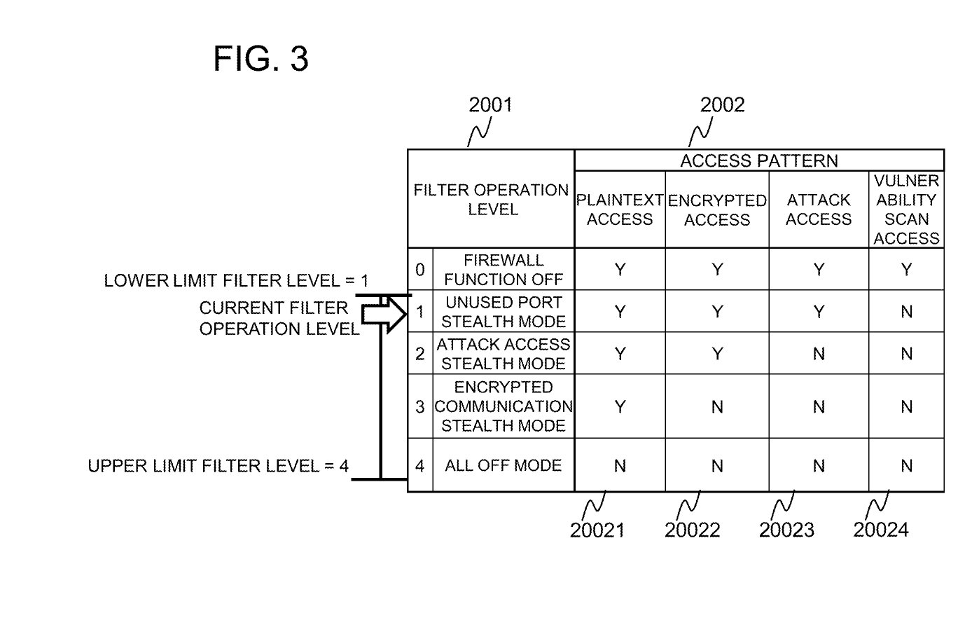

FIG. 3 illustrates an example of the relationship between the filter level and the types of the network packets to be abandoned. The drawing illustrates the concept of how the network packets are processed according to the respective filter levels in the packet filtering process according to the present embodiment, and not all the information illustrated in FIG. 3 is stored as it is in the storage system 1.

The values 0 through 4 stored in column 2001 are filter levels (or “filter operation levels”), and column 2002 shows the types of packets being filtered according to the filter level 2001. In the storage system 1 of the present embodiment, the network packets received by the storage system 1 via the management I/F 119 are classified into one of the following types of packets; a plaintext access packet, an encrypted access packet, an attack access packet, and a vulnerability scan access packet. The alphabets “Y” and “N” shown in the respective rows of column 2002 (columns 20021, 20022, 20023 and 20024) indicate whether that network packet is passed (not filtered) or not passed (filtered).

The definitions of the plaintext access packet, the encrypted access packet, the attack access packet and the vulnerability scan access packet according to the present embodiment will be described. At first, a vulnerability scan access packet refers to a network packet designating a port that is not opened in the storage system 1, or a network packet designating an opened port but where the network packet is received with extremely high frequency (Here, a port refers to a TCP/IP protocol port. When a computer connected to a network performs a network communication based on TCP/IP protocol, access is performed by designating a port number determined uniquely in advance by the program or the protocol to be used, but in order to ensure security, it is common in many computers to provide a setting to receive only the network packet designating a port number utilized by the program or the protocol being used in that computer. The port designated by the network packet being received is called an “opened port”, and other ports are called an “unopened port”). In the storage system 1 according to the present embodiment, the packet reception program 1006 confirms the port number of the respective network packets arriving at the storage system 1 and the frequency of arrival of network packets, and when a packet designating an unopened port or a highly frequent access packet is detected, the program stores the transmission source IP address of that packet. Thereafter, the storage system 1 assumes that the packet received from that transmission source IP address is a vulnerability scan access packet. The details of this process will be described later.

Next, an attack access packet refers to an abnormal packet, which is a network packet designating an opened port but the contents and format of the packet differs from the contents and format determined by the program using the data of that network packet (such as the network API section 1008 or the storage management program 1002). In the storage system 1 according to the present embodiment, the network API section 1008 analyzes the contents of each network packet reaching the storage system 1, detects the attack access packet, and stores the transmission source IP address of that packet. Thereafter, the storage system 1 assumes that the packet received from that transmission source IP address is an attack access packet. The details of this process will be described later.

An encrypted access packet refers to a network packet which is not classified into the above-described vulnerability scan access packet or the attack access packet, and it is highly possible that the packet is a normal network packet, but the contents of the packet is encrypted. As described earlier, the storage system 1 according to the present embodiment supports an encrypted communication via https (communication according to a so-called SSL (Secure Sockets Layer) protocol) other than the http protocol in communicating with the management terminal 3, so that the storage system 1 determines that the network packet designating a port number used for SSL protocol (such as port number 443) is an encrypted access packet. Further according to the storage system 1 of the present embodiment, when the system 1 performs encrypted communication with the management terminal 3, a port having a port number 25832 is used in addition to port number 443, so that in the packet filtering process according to the present embodiment, it is determined that the network packet designating port number 25832 is also an encrypted access packet.

A plaintext access packet is a network packet that is not classified into any of the vulnerability scan access packet, the attack access packet or the encrypted access packet, so that it is a normal network packet and not an encrypted communication packet.

Next, we will describe the relationship between the filter level and the plaintext access packet, the encrypted access packet, the vulnerability scan access packet and the attack access packet. As shown in FIG. 3, when the filter level 2001 refers to row 1, “N” is entered to only the column corresponding to the vulnerability scan access packet and “Y” is entered to the columns corresponding to other access packets. This means that only the vulnerability scan access packet out of the packets arriving at the management I/F 119 is filtered (abandoned). Similarly, when the filter level 2001 is 2, the attack access packet and the vulnerability scan access packet are filtered, and when the filter level 2001 is 3, the attack access packet, the vulnerability scan access packet and the encrypted access packet are filtered (meaning that only the plaintext access packet is received). When the filter level 2001 is 3, even if the packet is not an unauthorized access packet, the reason why the encrypted access packet is filtered is that when the filter level 2001 is high, it means that the I/O performance of the storage system 1 should preferably not be deteriorated, so that packets requesting a process requiring a high processor processing load, such as an encryption/decryption process, are not received.

When referring to a row where the filter level 2001 is 0, “Y” is entered in the respective columns corresponding to the plaintext access packet, the encrypted access packet, the attack access packet and the vulnerability scan access packet. This means that all the packets having reached the management I/F 119 is passed through (not filtered) without being abandoned. Further, when the filter level 2001 is 4, “N” is entered in all the columns, which means that all the network packets are abandoned. In other words, when the filter level 2001 is 4, all the network packets reaching the management I/F 119 is abandoned, and even if the packet is a normal management operation request issued from the management terminal 3, it will be abandoned.

Therefore, when the filter level 2001 is set to 1 at a certain point of time, the vulnerability scan access packet will be filtered but the other packets will not be filtered. Thereafter, when the filter level 2001 is changed to 3, all the packets other than the plaintext access packet will be filtered.

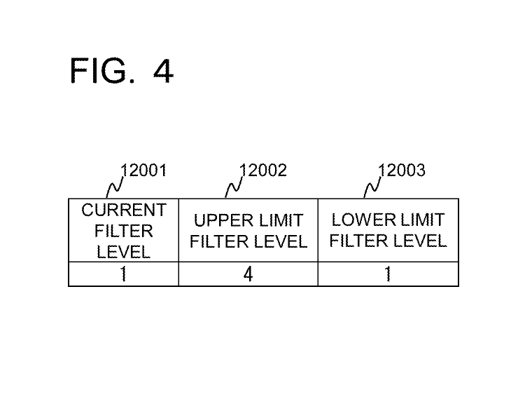

FIG. 4 illustrates the contents of a filter level information 1200 that the storage system 1 has. A current filter level 12001 stores the value representing the current filter level, and according to the embodiment of the present invention, a value between 0 and 4 is stored. Based on this value, the storage system 1 selects the types of packets to be filtered. An upper limit filter level 12002 and a lower limit filter level 12003 are values set by the administrator of the storage system 1, and the details thereof will be described hereafter.

The upper limit filter level 12002 and the lower limit filter level 12003 will now be explained. The upper limit filter level 12002 and the lower limit filter level 12003 are values corresponding to the “upper limit filter level” and the “lower limit filter level” illustrated in FIG. 3. The aforementioned filter levels are values automatically determined by the storage system 1 based on the tendency of I/O requests that the storage system 1 receives from the hosts 2, but in the present embodiment, the administrator of the storage system 1 can restrict the fluctuation range of the filter level. As the information for restricting the fluctuation range of the filter level, the administrator of the storage system 1 sets up the upper limit filter level 12002 and the lower limit filter level 12003. As described earlier, when the filter level is set to 3 or higher, even a network packet transmitting a normal management operation request issued by the management terminal 3 will be abandoned. However, there may be a case where it is not convenient to disable reception of normal management operation requests even temporarily, so that the administrator can set the upper limit filter level 12002 to 2, for example, to prevent the filter level from being set to 3 or higher values.

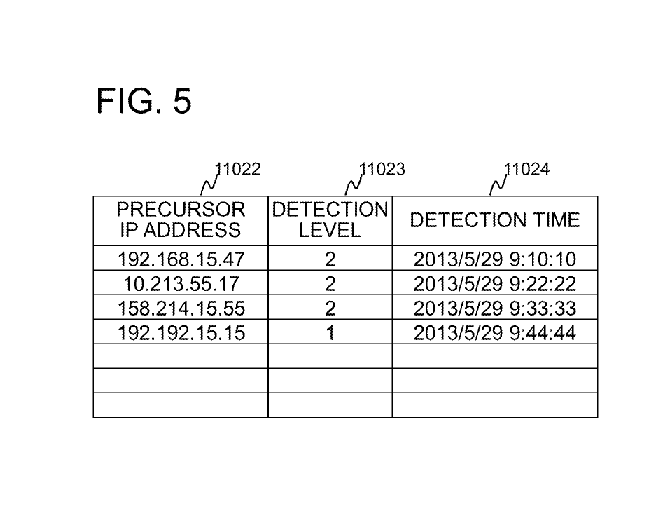

Next a precursor IP list 1102 illustrated in FIG. 5 will be described. When the storage system 1 receives a network packet via the management I/F 119, if it is detected that the network packet is a packet corresponding to the definition of a vulnerability scan access packet or an attack access packet, the request source (transmission source) IP address of the network packet is stored, and the stored request source IP address will be used thereafter for abandoning network packets arriving from that request source IP address. The respective entries (rows) of the precursor IP list 1102 are configured from the following items: a precursor IP address 11022, a detection level 11023, and a detection time 11024. The precursor IP address 11022 stores the request source IP address of the network packet being determined as a vulnerability scan access packet or an attack access packet out of the network packets received by the storage system 1, and the detection time 11024 stores the time when the network packet has arrived. The detection level 11023 stores information indicating whether the network packet received by the storage system 1 is a vulnerability scan access packet or an attack access packet. The detailed processes for storing the detection level 11023 will be described later, but when the received network packet is determined to be an attack access packet, “2” is stored in the detection level 11023, and when the received network packet is determined to be a vulnerability scan access packet, “1” is stored in the detection level 11023.

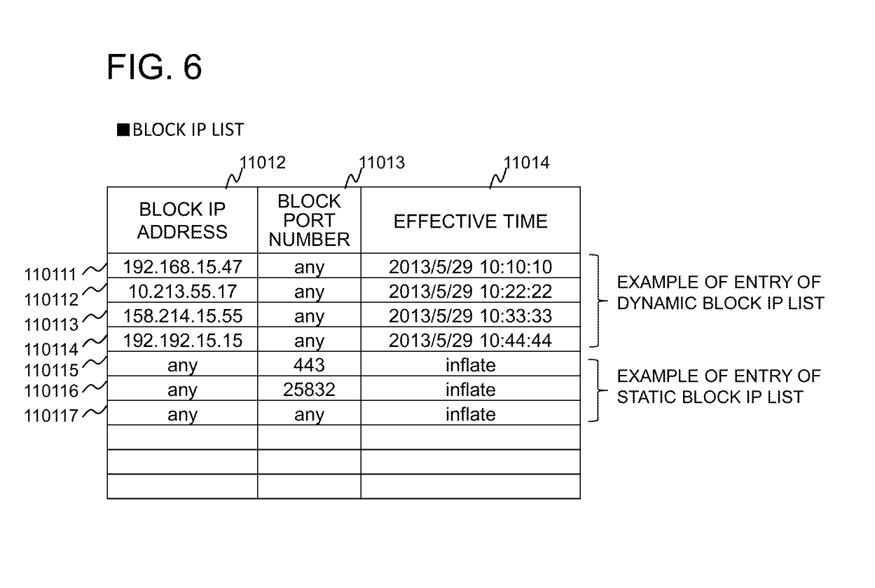

Next, the block IP list 1101 will be described with reference to FIG. 6. The storage system 1 according to the present embodiment performs filtering of network packets based on the information stored in the block IP list 1101.

The respective entries (rows) of the block IP list 1101 are composed of the following items: a block IP address 11012, a block port number 11013, and an effective time 11014. Out of the network packets arriving at the storage system 1, the storage system 1 abandons (block-filters) a network packet having a request source IP address corresponding to the IP address stored in the block IP address 11012, a port number having a block port number 11013, and an arrival time of the network packet at a time prior to the effective time 11014.

With reference to FIG. 6, there is a row (entry) where “any” is entered in rows of the block IP address 11012 or the block port number 11013, and when such value is entered, the network packet arriving from an arbitrary IP address or designating an arbitrary port number will be abandoned. Further, there is a row storing information stating “inflate” in the column of effective time 11014 (such as row 110115), and in this case, the network packet corresponding to the condition of that row will be abandoned regardless of the time of arrival of the network packet. For example, referring to the information stored in the beginning row (row 110111) of FIG. 6, the block IP address 11012 is “192.168.15.47”, the block port number 11013 is “any” and the effective time 11014 is “2013/5/29 10:10:10”, so that based on this information, the storage system 1 abandons an arbitrary network packet (designating an arbitrary port number) in which the request source IP address is “192.168.15.47” and which arrived before 10:10:10 of May 29, 2013. Similarly, based on the information of the fifth row of FIG. 6 (row 110115), the block port number 11013 is “443” but the other information are set to “any” or “inflate”, so that an arbitrary network packet designating port number “443” will be abandoned.

Further according to FIG. 6, there are rows (entries) where the block IP addresses 11012 are designated, such as rows 110111 through 110114, and rows (entries) where the block IP addresses 11012 are not designated, such as rows 110115 through 110117. According to the embodiment of the present invention, the entry having the block IP address 11012 designated is referred to as a “dynamic rule entry”, and the entry not having the block IP address 11012 designated is referred to as a “static rule entry”. The dynamic rule entry is an entry registered dynamically, triggered by the arrival of an apparently abnormal network packet, such as a vulnerability scan access packet, via the management network 6, which is an entry added to the block IP list 1101 when a network packet which seems to be a vulnerability scan access packet is received when the filter level is set to 1 or higher, or when a network packet which seems to be a vulnerability scan access packet or an attack access packet is received when the filter level is set to 2 or higher. On the other hand, the static rule entry is an entry set and registered statically regardless of whether a network packet has arrived from the exterior or not, which is added when the filter level is set to 3 or higher (in other words, the static rule entry will be entered to the block IP list 1101 when the filter level is set to 3 or higher, regardless of whether a vulnerability scan access packet or the like is received from the outside). Actual processes for adding the dynamic rule entry and the static rule entry will be described in detail later.

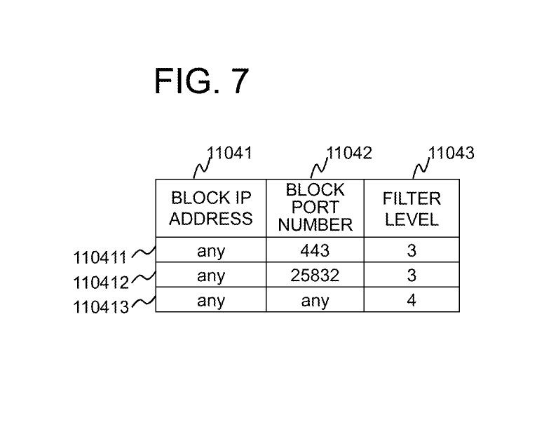

FIG. 7 illustrates the contents of the static rule list 1104. The static rule list 1104 is a list storing candidates of entries (static rule entries) to be registered in the block IP list 1101 when the filter level is set to 3 or higher. The respective rows of the static rule list 1104 include columns storing a block IP address 11041, a block port number 11042 and a filter level 11043. The contents of each row illustrate the contents of packets to be blocked according to filter levels designated in the filter level 11043. The entry of the first row (row 110411) indicates that when the filter level 11043 is set to 3, a network packet having 443 as the designated port number and an arbitrary address as the request source IP address, in other words, a network packet used for encrypted communication, should be filtered. The entry of the third row (row 110413) indicates that when the filter level 11043 is set to 4, a network packet having an arbitrary request source IP address and an arbitrary port number, in other words, all network packets, should be filtered. According to storage system 1 of the present embodiment, the contents of the static rule list 1104 are set in advance, and the contents thereof cannot be changed. However, as another embodiment, it is possible to provide a means enabling the contents of the static rule list 1104 to be added or updated from the management terminal 3.

We will now return to the description of FIG. 6. In FIG. 6, the entries of row 110115, row 110116 and row 110117 store contents stored in the block IP address 11041 and the block port number 11042 of the static rule list 1104 of FIG. 7. This is for executing the packet filtering process by storing the contents of the static rule list 1104 in the block IP list 1101 when the filter level is 3 or higher, but the details of the flow of processes regarding FIGS. 6 and 7 will be described later.

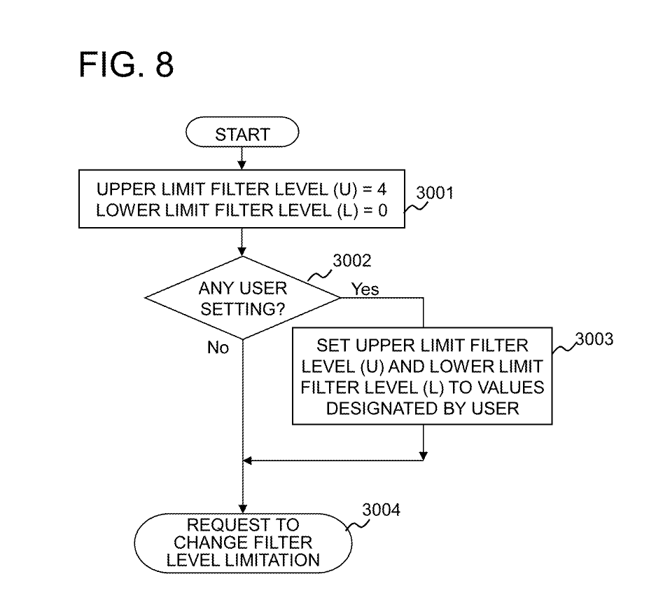

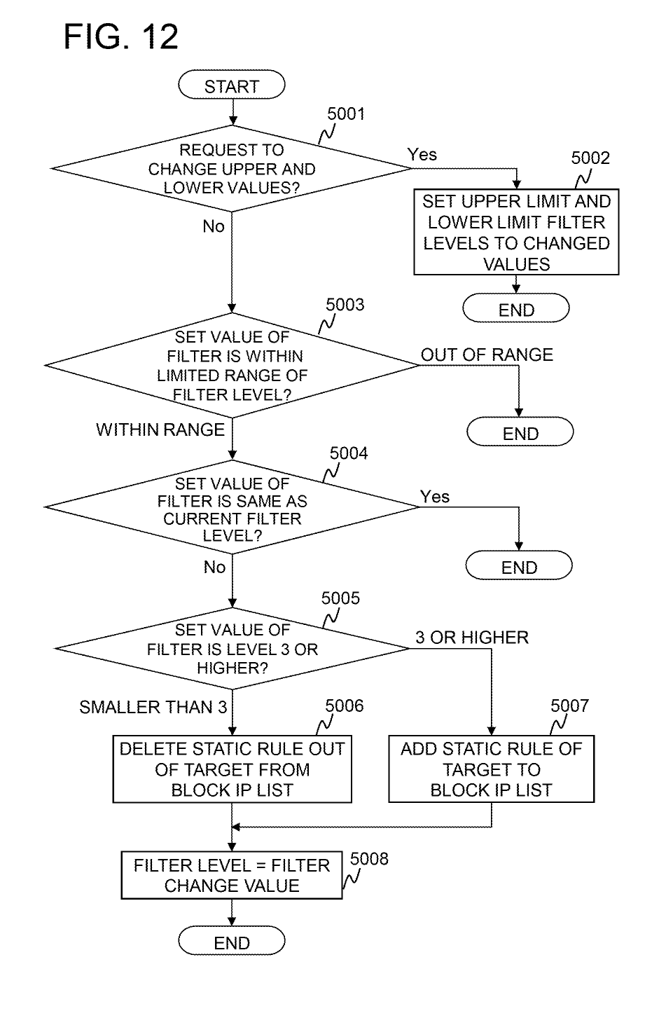

Next, the process related to changing the filter level performed by the storage system 1 according to the present embodiment will be described with reference to FIGS. 8 through 12. At first, the process of setting the upper limit and lower limit filter levels will be described. FIG. 8 is a flowchart illustrating the process flow of setting the upper limit and the lower limit of the filter level executed by the filter level user setting program 1003. When the administrator requests to set up the upper limit and the lower limit of the filter level using a WWW browser of the management terminal 3, the processor 111 of the storage system 1 starts to execute the filter level user setting program 1003. The filter level user setting program 1003 prepares a variable U for setting the upper limit filter level and a variable L for setting the lower limit filter level, and initial values 4 and 0 are set as the respective variables U and L (step 3001). Thereafter, the filter level user setting program 1003 displays an entry screen for entering the upper limit and lower limit filter levels on the WWW browser of the management terminal 3, and the administrator enters the upper limit and lower limit filter levels via the entry screen. The entered upper limit and lower limit filter levels are returned to the MP package via the management I/F 119. In step 3002, when the filter level user setting program 1003 detects reception of the upper limit and lower limit filter levels entered by the administrator, it sets the upper limit and lower limit filter levels entered by the administrator as variables U and L, respectively, and invokes the filter level management program 1005 (step 3004). Thereby, the filter level management program 1005 of FIG. 12 is started, and the details of this process will be described later. When invoking the filter level management program 1005, the filter level user setting program 1003 hands over the values of variables U and L to the filter level management program 1005.

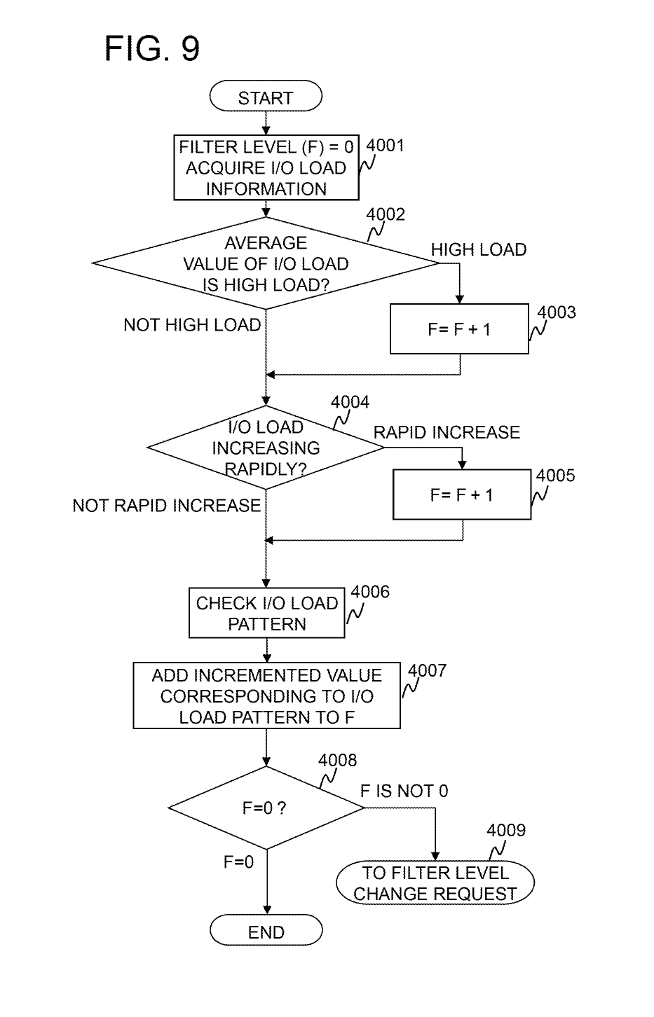

Next, the process of changing the filter level will be described with reference to FIG. 9. The changing of filter level is performed by the execution of the I/O access pattern analyzing program 1004. The I/O access pattern analyzing program 1004 is executed at periodical cycles, such as once in a few minutes, or once in a few hours.

In step 4001, the I/O access pattern analyzing program 1004 prepares a variable F for setting the filter level, and sets an initial value 0 as the variable F. Thereafter, the I/O access pattern analyzing program 1004 acquires a performance information (load information) of the storage system 1 acquired by the load monitoring function of the I/O processing program 1001. The load information acquired from the I/O processing program 1001 includes the following information.

(1) The load of the whole storage system 1 at the present time (IOPS and MB/sec): This information indicates an average value of the load (IOPS and MB/sec) of the respective volumes (logical volumes) within the storage system 1.

(2) The load change rate of the storage system 1: The storage system 1 stores the load at a point of time prior to (a few seconds prior to or a few minutes prior to) a given time in the past, in addition to the function for acquiring (1) the load of the storage system 1 at the present time. By using (1) and the load information at a point of time in the past, the load change rate (for example, how much IOPS load has increased during a unit time) can be computed and handed over to the I/O access pattern analyzing program 1004.

(3) Load breakdown of storage system 1: The storage system 1 classifies the accesses from the host 2 to the volumes of the storage system 1 into sequential read, sequential write, random read and random write, and calculates the access load of each classification (MB/sec in the case of sequential read/write, and IOPS in the case of random read/write). Well-known methods can be used for determining what types of accesses are determined as sequential read/write, and what types of accesses are determined as random read/write. As an example, in the I/O processing program 1001 of the present embodiment, when a request to read/write data having a length equal to or greater than a given length arrives from the host 2, those accesses are determined as sequential read/write accesses, and the data length subjected to sequential read or write is divided by the processing time of that read or write processing, to thereby compute a sequential read/write performance (MB/sec). The request not determined as being a sequential read/write access is determined as a random read/write access, and the performance (IOPS) thereof is computed (by dividing the number of random read/write requests by the time required for processing the requests).

The I/O access pattern analyzing program 1004 determines whether the filter level must be changed or not based on the load information acquired from the I/O processing program 1001 after step 4002.

In step 4002, the load (IOPS) at the current point of time of the whole storage system 1 is referred to, and whether the load is equal to or greater than a given value (such as threshold 1, wherein threshold 1 is a non-negative value) (whether the storage system 1 is at a high load status) is determined. When it is determined that the load is equal to or greater than the given value (that the load is high), 1 is added to variable F (step 4003), and then the procedure advances to step 4004. When it is determined that the load is not equal to or greater than the given value (the state is not a high load), the procedure moves onto step 4004 without performing any operation.

In step 4004, the procedure refers to the load change rate of the storage system 1, and determines whether the load change rate is equal to or greater than a given value (such as threshold 2. Threshold 2 is a non-negative value, and in the present embodiment, it is a value that differs from threshold 1, but in other embodiments, it can be equal to the value of threshold 1). When the load change rate is equal to or greater than the given value, 1 is added to variable F (step 4005), and thereafter, the procedure advances to step 4006. When it is determined that the load change rate is not equal to or greater than the given value, the procedure advances to step 4006 without performing any operation.

In step 4006, the procedure refers to the load breakdown of the storage system 1 (sequential read performance, sequential write performance, random read performance, random write performance), and determines the load pattern applied on the storage system 1.

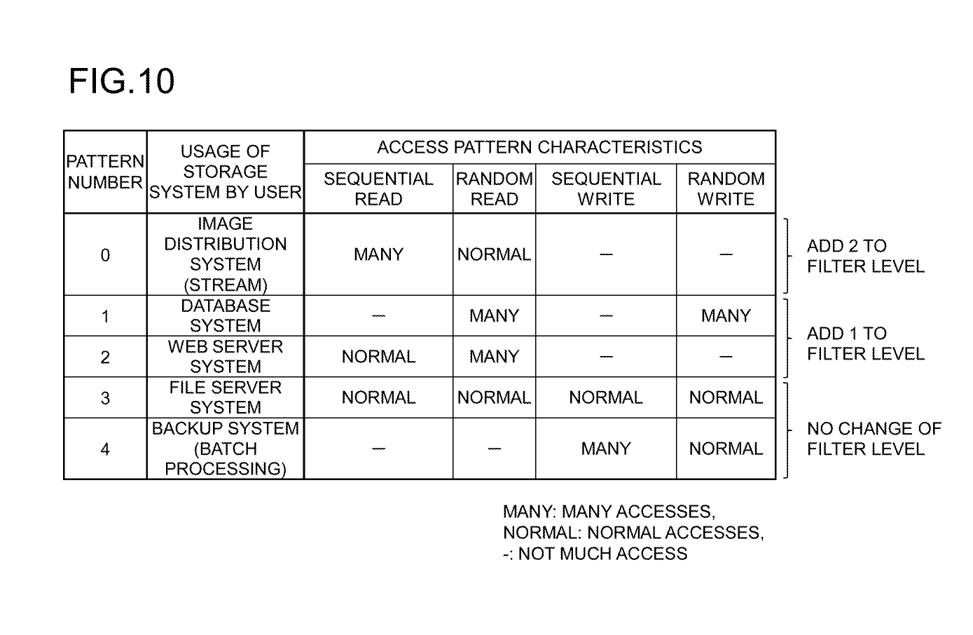

The load pattern will now be described. According to the preferred embodiment of the present invention, the load breakdown of the storage system 1 is referred to in order to determine whether the load status of the storage system 1 belongs to any one of the following five patterns: pattern 0, pattern 1, pattern 2, pattern 3 or pattern 4; or does not belong to any of these five patterns. The concept of the classification of load status (load pattern) according to the present embodiment will be described with reference to FIG. 10.

FIG. 10 illustrates the relationship between the operation (or the application program) performed at host 2 and the I/O access tendency from the host 2 to the storage system 1, assuming the case where the operation performed at host 2 is an image distribution operation, an online transaction processing (OLTP) operation, a Web server operation, a file server operation, or a backup operation, and the load patterns generated by these operations are assumed to be patterns 0, 1, 2, 3 and 4, respectively.

When the host 2 is performing an image distribution-based operation (pattern 0), in general, many of the I/O requests to the storage system 1 are sequential read requests. In such operation, in many cases, not even a temporal I/O deterioration is permitted. When OLTP (pattern 1) is performed at the host 2, random read requests and random write requests tend to increase as I/O requests to the storage system 1, and when the host 2 is used as a Web server (pattern 3), many of the I/O requests to the storage system 1 are read requests, especially random read requests. These operations also do not prefer fluctuation of I/O performance. When the host 2 is utilized as the file server of a document file in an office or the like (pattern 4), not many I/O requests having a high load is sent to the storage system 1, and in many cases, a middle level I/O occurs. When backup operation (using storage system 1 as the backup destination storage media) is performed in host 2 (pattern 5), there are many sequential write requests.

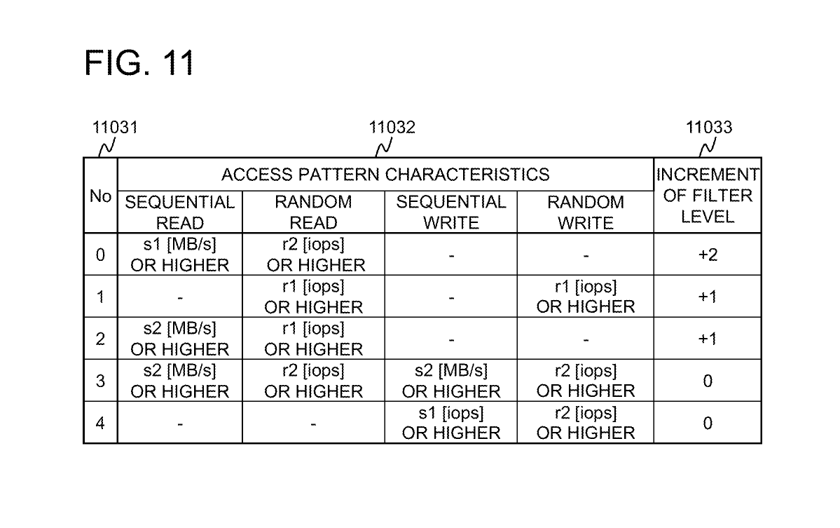

In the preferred embodiment of the present invention, the corresponding pattern of the load status of the storage system 1 is identified based on the above-described concept. For this identification, the storage system 1 retains the I/O pattern list 1103 illustrated in FIG. 11. The respective entries (rows) correspond to the load patterns 0 through 4. Column 11031 stores the pattern numbers, and in the case of the present embodiment, pattern numbers 0 through 4 are stored. Column 11032 stores information related to the access pattern characteristics, and conditions (conditions (a) through (e) described below) of the sequential read performance, the sequential write performance, the random read performance and the random write performance corresponding to each pattern are stored.

(a) Pattern 0: The case of a load status where the sequential read access is s1 (MB/sec) or higher and the random read access is r2 (IOPS) or higher.

(b) Pattern 1: The case of a load status where both the random read access and the random write access is r1 (IOPS) or higher.

(c) Pattern 2: The case of a load status where the sequential read access is s2 (MB/sec) or higher and the random read access is r1 (IOPS) or higher.

(d) Pattern 3: The case of a load status where both the sequential read access and the sequential write access are s2 (MB/sec) or higher, or both the random read access and the random write access are r2 (IOPS) or higher.

(e) Pattern 4: The case of a load status where the sequential write access is s1 (MB/sec) or higher and the random write access is r2 (IOPS) or higher.

Further, s1, s2, r1 and r2 are all non-negative values, satisfying a relationship of s1>s2, r1>r2.

In the example of FIG. 11, column 11033 is a column storing the incremental value of filter level, which shows that if the load status of the storage system 1 corresponds to pattern 0, it is determined that image distribution operation is performed in host 2, and the filter level is incremented by 2, wherein if the load status corresponds to pattern 1 or pattern 2, it is determined that OLTP or Web server operation is performed in host 2, and the filter level is incremented by 1, and in other cases, the filter level is not incremented.

We will now return to the description of FIG. 9. In step 4006, the load breakdown of the storage system 1 and the I/O pattern list 1103 are referred to, and the procedure determines which load status out of patterns 0 through 4 the load status of storage system 1 corresponds to. In step 4007, the increment value stored in the filter level increment 11033 corresponding to the pattern is added to variable F. As mentioned earlier, in the example of FIG. 11, if the load status corresponds to patterns 0 through 2, the filter level is incremented (by 1 or 2).

In step 4008, whether the variable F is 0 or not is determined, and if F equals 0, the procedure is ended. If F is not 0, the procedure advances to step 4009 (request to change restriction level), and requests to set up the filter level to the filter level management program 1005.

In step 4009, the I/O access pattern analyzing program 1004 invokes the filter level management program 1005. Thereby, the filter level management program 1005 of FIG. 12 is started. Further, upon invoking the filter level management program 1005, the I/O access pattern analyzing program 1004 hands over the value of variable F to the filter level management program 1005.

The processes executed by the filter level management program 1005 will be described with reference to FIG. 12. The filter level management program 1005 performs the setting of the upper limit value and lower limit value of the filter level designated by the administrator, and/or sets the filter level determined by the I/O access pattern analyzing program 1004 and performs the information setting accompanying the same.

Steps 5001 and 5002 are processes for setting the upper limit value and the lower limit value of the filter level designated by the administrator. In step 5001, the filter level management program 1005 determines whether the source invoking the filter level management program 1005 is the filter level user setting program 1003 or the I/O access pattern analyzing program 1004. If it is invoked by the filter level user setting program 1003, the procedure advances to step 5002, and the values of variable U (upper limit filter level) and variable L (lower limit filter level) provided from the filter level user setting program 1003 are respectively set as the upper limit filter level 12002 and the lower limit filter level 12003 of the filter level information 12002, and thereafter, the process is ended.

In step 5001, if it is determined that the source having invoked the filter level management program 1005 is the I/O access pattern analyzing program 1004, the procedure advances to step 5003. In step 5003, whether the filter level designated by the I/O access pattern analyzing program 1004 (content of variable F) falls within the range determined by the upper limit filter level 12002 and the lower limit filter level 12003 in the filter level information 1200 is determined. If the value of variable F falls within the range determined by the upper limit filter level 12002 and the lower limit filter level 12003, the procedure advances to step 5004, but if the value does not fall within the range, the process is ended (the filter level is not changed).

In step 5004, the filter level designated by the I/O access pattern analyzing program 1004 (content of variable F) and the current filter level (current filter level 12001 of the filter level information 1200) are compared. If the content of variable F is the same as the value of the current filter level 12001, the process is ended, and if not, the procedure advances to step 5005.

In step 5005, it is determined whether variable F is equal to or higher than 3. If it is not equal to or higher than 3 (when the value is 0, 1 or 2), the procedure advances to step 5006, and deletes the static rule entry from the block IP list 1101. If the variable F is equal to or higher than 3, the procedure advances to step 5007.

In step 5007, a static rule entry is added to the block IP list 1101. In adding a static rule entry, the value of the filter level 11043 in the static list 1104 and the value of variable F are compared, and a raw information (entry) where the value of filter level 11043 of the static list 1104 is below the value of variable F is added to the block IP list 1101. That is, if the variable F (filter level after the change) is 3, only the static rule (blocking an encrypted communication packet) of the case of filter level 3 is added, and if the variable F is 4, the static rule of the case of filter levels 3 and 4 (blocking all communication packets) is added.

In step 5008, the value of variable F is stored in the current filter level 12001 of the filter level information 1200, and the process of the filter level management program 1005 is ended.

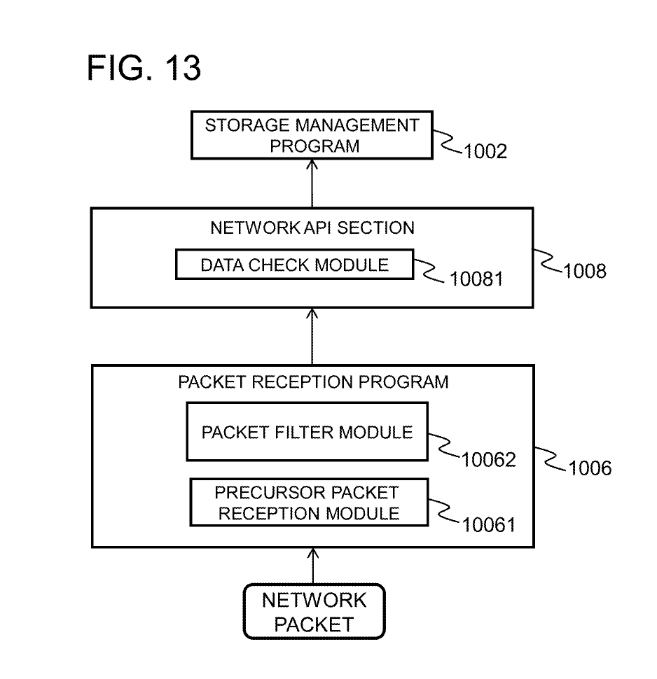

Next, the (packet filtering) process that the storage system 1 according to the present embodiment performs to restrict the network access will be described. At first, the relationship between the packet reception program 1006 and the network API section 1008 which are programs related to the process for restricting network accesses will be described with reference to FIG. 13. The packet reception program 1006 is a program for receiving a network packet from the management I/F 119, which analyzes the network packet according to TCP/IP protocol. Further, the network API section 1008 is a group of programs performing processes according to protocols and services that are of upper layers than the TCP/IP protocol, and this group of programs are executed by being invoked from a program (such as the storage management program 1002) communicating with external devices and equipments via the management I/F 119. The network packet received by the packet reception program 1006 is acquired by the network API section 1008, and the network API section 1008 performs processes to hand over the data within the packet to the program being the source invoking the network API section 1008 (such as the storage management program 1002).

As shown in FIG. 13, the packet reception program 1006 according to the present embodiment includes a precursor packet reception module 10061 and a packet filter module 10062. The precursor packet reception module 10061 is a program for detecting the port number designated by the received network packet and the packet arriving frequency, and when the port number and the packet arriving frequency correspond to given conditions, determining that the transmission source device and equipment of the packet is performing a vulnerability scan access, and performing a process for registering the IP address of the transmission source device and equipment of the relevant packet to the precursor IP list 1102. Further, the packet filter module 10062 is a program for filtering the arriving network packet based on the contents of the block IP list 1101.

Further, (the group of programs of) the network API section 1008 includes a data check module 10081. The data check module 10081 confirms the data format and the like of the received network data, and when the content of the data is abnormal, it determines that the transmission source device/equipment of the data is carrying out an attack access, and performs a process to register the IP address of the transmission source device/equipment of the relevant data to the precursor IP list 1102.

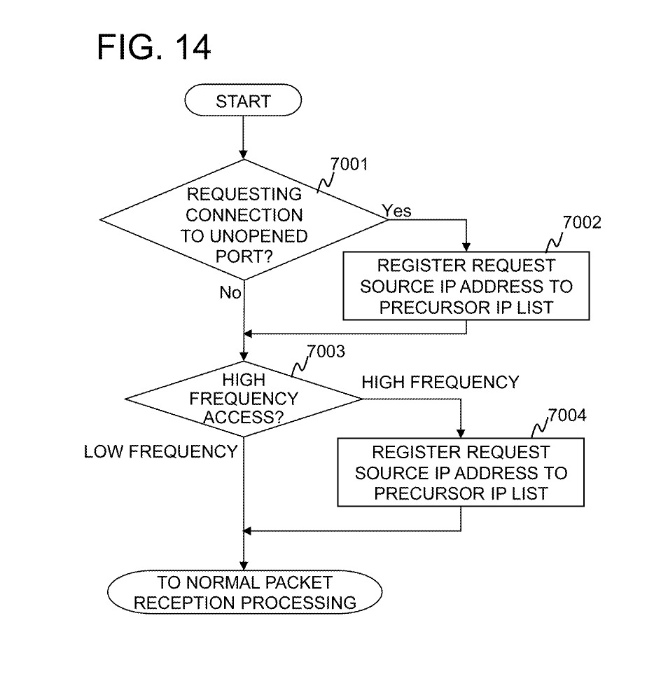

Now, the processes of the respective programs mentioned above will be described with reference to FIGS. 14 through 17. At first, process details of the precursor packet reception module 10061 and the data check module 1008 which are programs performing a process for registering information to the precursor IP list 1102 will be described, and thereafter, process details of the packet filter module 10062 which is a program performing filtering (abandoning) of the packet will be described.

With reference to FIG. 14, the process of the precursor packet reception module 10061 within the packet reception program 1006 will be described. When the network packet reaches the management I/F 119, the execution of the packet reception program 1006 is started. The packet reception program 1006 invokes the precursor packet reception module 10061 immediately after being started, and confirms the contents of the network packet reaching the same. The process illustrated in FIG. 14 is a process executed by the precursor packet reception module 10061 when the precursor packet reception module 10061 is invoked by the packet reception program 1006.

The network packet of the format according to the TCP/IP protocol includes within the packet an IP address (this IP address is referred to a “request source IP address” or a “transmission source IP address” in the present specification) of the device (an equipment such as a terminal) having transmitted the packet, and the port number. The precursor packet reception module 10061 mainly uses this request source IP address and the port number to record information in the precursor IP list 1102. In step 7001, the precursor packet reception module 10061 refers to the port number of the arriving network packet, and determines whether the arriving network packet is a packet designating an unopened port in the storage system 1 or not. If the packet designates an unopened port, the information of the request source IP address included in the network packet is stored in the precursor IP address 11022 of the precursor IP list 1102, and stores the time (using the time information acquired from a clock (not shown) in the storage system 1) in the detection time 10024. At the same time, value “1” is stored in the detection level 11023 (step 7002).

In step 7003, whether the network packet is arriving at a high frequency or not is determined. Specifically, the request source IP address of the network packet is referred to, and whether network packets designating the same request source IP address have arrived for a determined number of times or more within a given time is determined. If it is determined that network packets designating the same request source IP address have arrived for a determined number of times or more within a given time, the same process as step 7002, that is, the process of storing the information of the request source IP address included in the network packet, the detection time and the detection level in the precursor IP list, is performed (step 7004). The process performed by the precursor packet reception module 10061 is ended, and thereafter, a process is executed by the packet reception program 1006 regarding the received network packet (such as the process illustrated in FIG. 11), which will be described later.

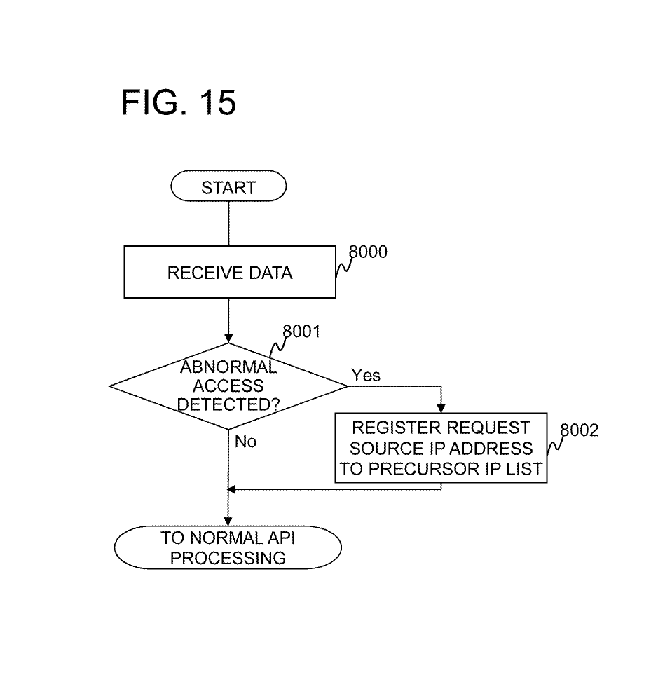

Thereafter, the processing of the network API section 1008 (data check module 10081) will be described with reference to FIG. 15. The network packet having been processed by the packet reception program 1006 will be processed by the network API section 1008, and in the network API section 1008, the data check module 10081 is invoked at first to have the data check module 10081 perform a packet content determination processing.

At first, in step 8000, the data check module 10081 acquires network data from the packet reception unit.

In step 8001, the module confirms the data format and the like of the received network data, and determines whether it is a normal data content (for example, whether it is based on a data format determined by an upper layer protocol) or not. If it is not a normal data content, the module determines that an abnormal access request has arrived, and registers the information of the request source IP address of the relevant network data to the precursor IP list 1102 (step 8002). In the registration process of step 8002, the information of the request source IP address included in the network data is stored in the precursor IP address 11022, and the time is stored in the detection time 11024. At the same time, value “2” is stored in the detection level 11023. Thereafter, the received data is handed over to the network API section 1008 and processed in the network API section 1008, but the process performed in the network API section 1008 is similar to the process performed in a well-known network API, so the description of the contents thereof will be omitted.

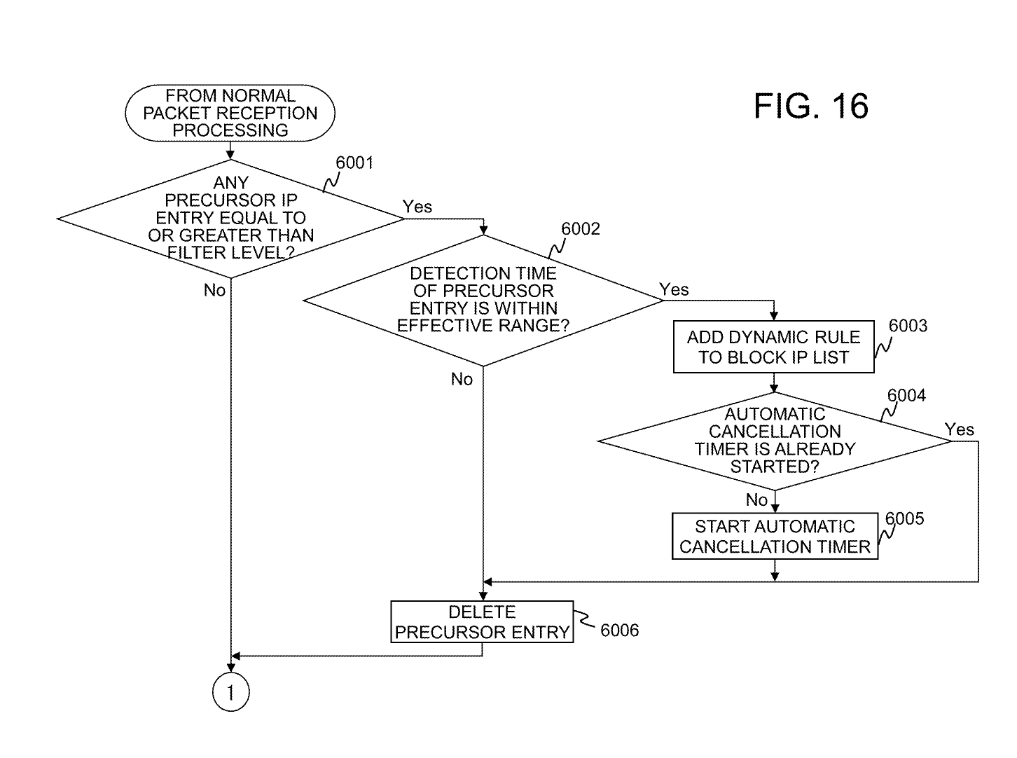

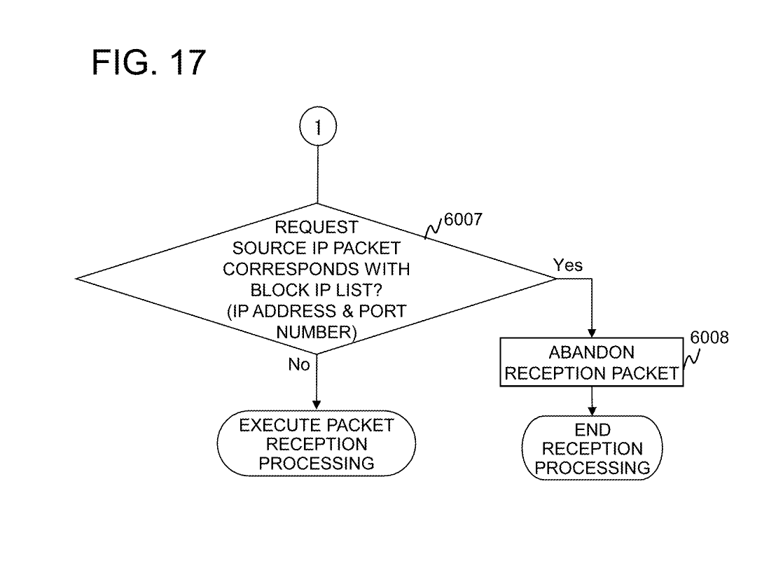

Next, a packet filter module 10062 which is a program for actually filtering (abandoning) packets will be described with reference to FIGS. 16 and 17. The precursor packet reception module 10061 and the data check module 10081 determine whether a packet considered to be a vulnerability scan access network packet or an attack access network packet has arrived at the storage system 1, and performs a process to register the request source IP address of the packet considered to be the vulnerability scan access network packet or the attack access network packet to the precursor IP list 1102, but they will not perform a process to abandon (filter) packets. The program that actually abandons the packets is the packet filter module 10062 described here.

The packet filter module 10062 is a program being invoked by the packet reception program 1006 and starting execution, similar to the precursor packet reception module 10061. Specifically, the packet filter module 10062 is invoked after the precursor packet reception module 10061 invoked from the reception program 1006 ends the process.

Further, in the former half (steps 6001 through 6006 of FIG. 16), the packet filter module 10062 performs a process to add a block entry to the dynamic rule entry, and in the latter half (steps 6007 and thereafter of FIG. 16), the module performs packet filtering.

At first, the processing performed at the former half section will be described. In step 6001, the packet filter module 10062 refers to the precursor IP list 1102 and the filter level information 1200, and determines whether an entry where the value of the detection level 11023 is equal to or greater than the current filter level (current filter level 12001 of the filter level information 1200) exists within the entries of the precursor IP list 1102. If there is no entry where the value of the detection level 11023 is equal to or greater than the current filter level, the processing of the former half section is ended, and the procedure advances to the processing of the latter half section (the processing of the latter half section will be described later). If there is an entry where the value of the detection level 11023 is higher than the current filter level, the procedure advances to step 6002.

In step 6002, out of the entries within the precursor IP list 1102, the detection time 11024 of each entry where the value of the detection level 11023 is equal to or greater than the current filter level will be referred to, and whether the detection time 11024 is within an effective range is determined. In the present embodiment, if the time acquired by adding a given time (such as one hour) to the detection time 11024 of the entry registered in the precursor IP entry 1102 is later than the current time (which is the time of execution of the processing of step 6002. Specifically, the time information of the clock (not shown) of the storage system 1 at the point of time of execution of processing of step 6002 is used as the current time), the procedure determines that the entry is an effective entry and proceeds to step 6003, but if not, the procedure determines that the entry is an ineffective entry and proceeds to step 6006. In other words, from the time the packet first arrives from the device or terminal having the IP address registered in the precursor IP entry 1102 to the elapse of a predetermined time (effective time), the packets arriving from the device or terminal having the IP address registered in the precursor IP entry 1102 are set as filter targets, but after the elapse of the effective time, they are not set as filter targets.

In step 6003, the entry determined to be effective in step 6002 out of the entries within the precursor IP entry 1102 is added to the block IP list 1101. In adding the entry, the precursor IP address 11022 of the entry determined as effective is stored in the block IP address 11012 of the block IP list 1101, and “any” is stored in the block port number 11013 corresponding to the block IP address 11012. Further, the row of the effective time 11014 stores the time having added a predetermined time (one hour) to the detection time 11024 of the entry determined as effective.

In steps 6004 and 6005, a processing to prepare start of the IP block cancellation program 1009 mentioned later is performed. The details will be described later, but the IP block cancellation program 1009 is a program started periodically via a so-called timer interrupt processing, and in the present embodiment, a timer (automatic cancellation timer 1010) for starting the IP block cancellation program 1009 is started. The automatic cancellation timer 1010 is a program for starting the IP block cancellation program 1009 after a predetermined time (ten minutes, for example) has elapsed from when the program is started, and after the IP block cancellation program 1009 is started, the processing performed by the automatic cancellation timer 1010 itself is ended.

In step 6004, the procedure determines whether the automatic cancellation timer 1010 is already started or not, and if it is not started, the procedure advances to step 6005, and starts the automatic cancellation timer 1010 in step 6005. If it is already started, the procedure advances to step 6006 without performing any operation.

In step 6006, out of the entries of the procedure IP entry 1102, all the entries determined as having a value of the detection level 11023 equal to or greater than the current filter level in step 6001 are deleted. Thereby, the processing of the former half section of the packet filter module 10062 is ended, and thereafter, the processing of the latter half section is started.

The processing of the latter half section of the packet filter module 10062 will be described with reference to FIG. 17. In step 6007, the packet filter module 10062 determines whether the packet being the current processing target corresponds with any of the entries of the block IP list 1101 or not. Actually, regardless of the content of the current filter level value, the packet filter module 10062 compares the request source IP address and the port number of the current processing target packet with the block IP addresses 11012 and the block port numbers 11013 of all the entries within the block IP list 1101, to determine whether they correspond or not. If they do not correspond, the processing of the packet filter module 10062 is ended, and the packet reception processing via the packet reception program 1006 is continued. When the packet reception processing via the packet reception program 1006 is completed, the processed packets are acquired by the network API section 1008 and the like, and they are subjected to predetermined processing.

In step 6007, when it is determined that the packet being the target of current processing corresponds with any of the entries within the block IP list 1101, the procedure advances to step 6008. In step 6008, the packet is abandoned, and thereafter, the processing of the packet filter module 10062 is ended. In that case, since the packet is abandoned, the processing of the relevant packet by the packet reception program 1006 is also ended.

Further according to the above-described embodiment, in the processing of step 6007, the packet filter module 10062 compares the request source IP address and the port number of the packet being the current processing target with all the entries in the block IP list 1101 regardless of the content of the current filter level, but according to another possible embodiment, the determination processing can be simplified, by referring to the filter level at the point of time of the processing. For example, when the filter level is set to 4, all the arriving packets are to be abandoned, so that it is possible to perform a processing to immediately abandon the packets without comparing the arriving packets with the respective entries of the block IP list 1101. When the filter level is set to 3, in comparing the processing target packet with the respective entries in the block IP list 1101, the packet is first compared with the static rule entry in the block IP list 1101, where only the port numbers are compared. Thereafter, the packet is compared with the dynamic rule entry, so that the load of the comparison processing can be reduced.

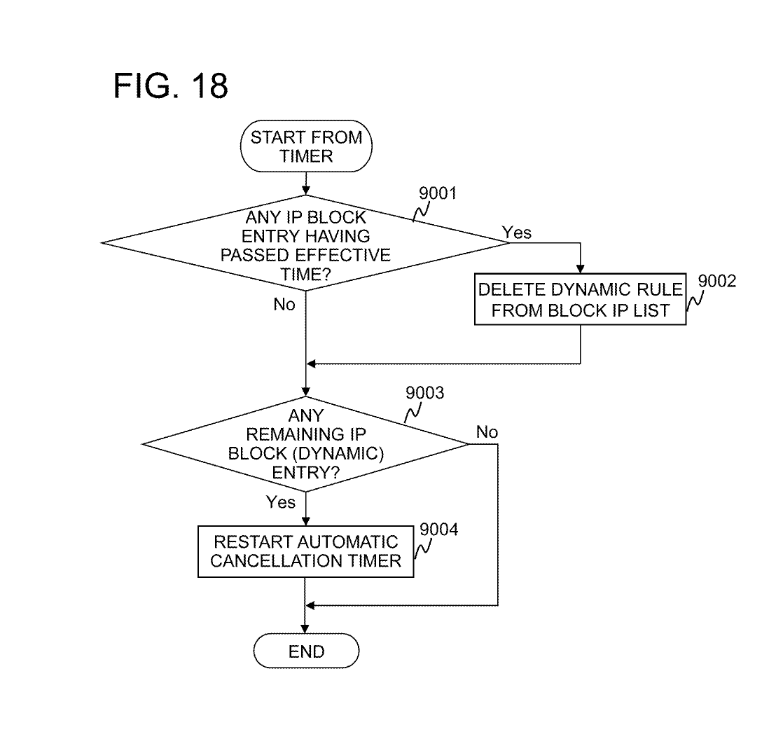

Thereafter, the processing of the IP block cancellation program 1009 will be described with reference to FIG. 18. As described earlier, the packet filter module 10062 filters the network packet being specified by the information of the entries in the block IP list 1101, wherein an effective time is defined for each of the respective entries in the block IP list 1101. Since the entry having passed the effective time (the effective time 11014 of the entry is older than the current time) is invalid (or unnecessary), the IP block cancellation program 1009 performs a processing to delete this unnecessary entry. As described earlier, the IP block cancellation program 1009 is started periodically by the automatic cancellation timer 1010.

Now, the processes performed after starting the IP block cancellation program 1009 will be described. In step 9001, the IP block cancellation program 1009 refers to the respective entries within the block IP list 1101, and determines whether there is an entry having passed the effective time, that is, whether there is an entry having the effective time 11014 older than the current time, and if there is no such entry, the program advances to step 9003, but if there is, the program advances to step 9002. In step 9002, all the entries having passed the effective time within the block IP list 1101 are deleted.

In step 9003, the IP block cancellation program 1009 determines whether a dynamic rule entry exists in the block IP list 1101, that is, whether a still effective dynamic rule entry exists in the list, and if there is no effective dynamic rule entry, the program ends the processing. If there is an effective dynamic rule entry, the program restarts the automatic cancellation timer 1010 to restart the IP block cancellation program 1009 after a predetermined time has elapsed (step 9004), and the IP block cancellation program 1009 ends the processing.

According to the storage system of the present embodiment, the types of the block-target packets out of the data packets arriving to the system via the management network can be increased or decreased dynamically according to the operation status (I/O load) of the storage system. Therefore, when it is determined that the I/O load of the storage system is high or that an important task (task requiring that the I/O performance is not deteriorated) is being executed by the host, the types of the packets being blocked (filtered) can be increased so as not to affect the I/O processing of the storage device, and if the I/O load of the storage system is reduced, the control can be varied automatically so as not to filter the packets. As a result, it is possible to prevent the temporal deterioration of I/O performance of the storage system without having to change the network setting or the like of the computer system.

According to the storage system of the present embodiment, once the arrival of the vulnerability scan access packet or the attack access packet is observed by the precursor packet reception module 10061 or the like, the filtering (abandoning) of packets is performed by merely determining the IP address or the port number by the packet filter module 10062 of the packet reception program 1006 described with reference to FIGS. 16 and 17. Therefore, it becomes possible to reduce the process of handing over a network packet to a higher level program (such as the network API section 1008 or the storage management program 1002), and there will be no need to analyze the contents of the arriving packets (such as to determine whether the packet is an attack access packet or not) by the higher level program. Therefore, as a whole, the processing load of the management task of the storage system 1 can be reduced, and the influence on the I/O task can be minimized. As the filter level increases, the types of packets being filtered by the packet filter module 10062 are increased, that is, the number of packets that must be processed by the higher level network API section 1008 or the storage management program 1002 can be reduced, so that by setting the filter level higher, the processing load of the management task of the storage system 1 can be reduced further.

The preferred embodiments of the present invention have been described above, but they are merely examples for describing the present invention, and they are not intended to limit the scope of the present invention. The present invention can be realized in other various forms. For example, the storage system described in the present embodiment can be designed to adopt a configuration where there are multiple MP packages 11, processors 111, host I/Fs 12, disk I/Fs 15, disk array units 17, management I/Fs 119 and the like within the storage system to realize an effective system.

Further according to the storage system 1 of the present embodiment, the system is controlled to filter the vulnerability scan access packet when the filter level is set to 1 and to filter the attack access packet in addition to the vulnerability scan access packet when the filter level is set to 2, but it is possible to arbitrarily change the type of packets to be filtered in each filter level. For example, it is possible to adopt a configuration to filter attack access packets when the filter level is set to 1, and to filter attack access packets and vulnerability scan access packets when the filter level is set to 2. Moreover, there are various possible methods for detecting packets such as vulnerability scan access packets and attack access packets which are considered as abnormal, and a method can be adopted where arrival of an attack access packet is detected when the port number designated in multiple packets arriving from a specific external equipment (IP address) is successive (incremented). According to the above-described embodiment, the filter level is selected from values between 0 and 4, but it is possible to increase the types of packets to be identified, and to have a value greater than 4 set as the filter level.

The method for changing the filter level can also be varied arbitrarily. According to the above-described embodiment, the filter level is changed based on the average value of I/O load to the logical volume or the I/O load variability, but it is possible to change the filter level based on other information. For example, various information can be used, as long as the information reflects the operation status of the storage system, such as the monitored value of the total I/O load, or the monitored value of the load of the processor 111 or the load variability thereof. As for the load pattern, it is possible to detect patterns other than the pattern described in the present embodiment.

According to the above embodiment, the attack access packet is detected by the data check module 10081 being invoked by the network API section 1008, but the attack access packet can be detected by programs other than the network API section 1008. For example, the present invention can be realized by adopting a configuration in which the data check module 10081 is included in an upper layer program such as the storage management program 1002 and the attack access packet is detected within the storage management program 1002.

Further, the configuration described as a program in the present embodiment can be realized by a hardware using a hard-wired logic or the like. It is also possible to adopt a configuration to store and provide the various programs and the control information described in the present embodiment in storage media such as CD-ROMs and DVDs.

### REFERENCE SIGNS LIST

1 Storage system
2 Host
3 Management terminal
4 Network monitoring server
5 Terminal
6 Management network
7 Storage area network (SAN)
11 MP package
12 Host I/F
13 Cache memory
14 Switch LSI
15 Disk I/F
16 Internal network
17 Disk array unit
18 Address/data signal line
111 Processor
112 Chip set
113 RAM
114 ROM
115 Front side bus (FSB)
116 Bus
117 Bus
119 Management I/F
171 HDD
1001 I/O processing program
1002 Storage management program
1003 Filter level user setting program
1004 I/O access pattern analyzing program
1005 Filter level management program
1006 Packet filter program
1008 Network API unit
1009 IP block cancellation program
1010 Automatic cancellation timer
1101 Block IP list
1102 Precursor IP list
1103 I/O pattern list
1104 Static rule list
1200 Filter level information

1. A storage system comprising a processor, one or more storage areas, a host interface for communicating with a host computer, and a management interface for connecting with a management network: wherein
the processor is configured to concurrently perform processing of an access request to the storage area from the host computer and processing of a network packet arriving via the management network, and receiving a network packet from one or more external devices arriving via the management network, identifying a type of the network packet, and abandoning a predetermined type of packets;
the storage system receives an access request from the host computer to the storage area, and monitors an access characteristics of the host computer to the storage area; and
based on the access characteristics, the storage system changes a filter level which is a number of the types of network packets to be abandoned.

2. The storage system according to claim 1, wherein
the external device includes a management terminal of the storage system, and the network packet includes information related to a management operation request of the storage system transmitted from the management terminal to the storage system via the management network.

3. The storage system according to claim 1, wherein
the storage system observes an access load to the storage area and/or a change rate of the access load to the storage area as access characteristics; and
the storage system increases the filter level when the access load is equal to or greater than a first threshold value, or if a change rate of the access load to the storage area is equal to or greater than a second threshold value.

4. The storage system according to claim 3, wherein
the storage system further analyzes a load pattern to the storage area as the access characteristics, and if the load pattern corresponds to a given pattern, increases the filter level.

5. The storage system according to claim 1, wherein
types of network packets to be abandoned include, at least,
(1) a packet designating an unopened port; and
(2) a packet whose data format differs from a given format;
wherein when a packet of a type corresponding to (1) or (2) arrives via the management network, if the filter level is equal to or greater than a third threshold, the storage system abandons the arriving packet.

6. The storage system according to claim 5, wherein
when a packet of a type corresponding to (1) or (2) arrives, the storage system stores an IP address of a transmission source device of the arriving packet; and
after storing the IP address, the storage system abandons a packet arriving via the management network having the same IP address as the IP address of the stored transmission source device.

7. The storage system according to claim 5, wherein
the type of the network packet to be abandoned further includes
(3) an encrypted communication packet; and
if a packet corresponding to type (3) arrives, if the filter level is equal to or greater than a fourth threshold which is greater than the third threshold, the storage system abandons the arriving packet.

8. The storage system according to claim 7, wherein
when the filter level is equal to or greater than a fifth threshold which is greater than the fourth threshold, the storage system abandons all packets arriving via the management network.

9. A method for controlling a storage system comprising a processor, one or more storage areas, a host interface for communicating with a host computer, and a management interface for connecting with a management network: wherein
the processor is configured to concurrently perform processing of an access request to the storage area from the host computer and processing of a network packet arriving via the management network, and receiving a network packet from one or more external devices arriving via the management network, identifying a type of the network packet, and abandoning a predetermined type of packets;
the storage system receives an access request from the host computer to the storage area, and monitors an access characteristics of the host computer to the storage area; and
based on the access characteristics, the storage system changes a filter level which is a number of the types of network packets to be abandoned.

10. The method for controlling a storage system according to claim 9, wherein
the external device includes a management terminal of the storage system, and the network packet includes information related to a management operation request of the storage system transmitted from the management terminal to the storage system via the management network.

11. The method for controlling a storage system according to claim 9, wherein
the storage system observes an access load to the storage area and/or a change rate of the access load to the storage area as access characteristics; and
the processor at least increases the filter level when the access load is equal to or greater than a first threshold value, or if a change rate of the access load to the storage area is equal to or greater than a second threshold value.

12. The method for controlling a storage system according to claim 11, wherein
the storage system further analyzes an access pattern to the storage area as the access characteristics, and if the access pattern corresponds to a given pattern, increases the filter level.

13. The method for controlling a storage system according to claim 9, wherein
types of network packets to be abandoned include, at least,
(1) a packet designating an unopened port;
(2) a packet whose data format differs from a given format; and
(3) an encrypted communication packet; wherein
when the filter level is equal to or greater than a third threshold, the storage system abandons packets corresponding to types (1) and (2) out of the packets arriving via the management network, and when the filter level is equal to or greater than a fourth threshold which is greater than the third threshold, the storage system abandons packets corresponding to types (1), (2) and (3) out of the packets arriving via the management network.

14. The method for controlling a storage system according to claim 13, wherein
when a packet of a type corresponding to (1) or (2) arrives, the storage system stores an IP address of a transmission source device of the arriving packet; and
after storing the IP address, the storage system abandons a packet arriving via the management network having the same IP address as the IP address of the stored transmission source device.

15. The method for controlling a storage system according to claim 13, wherein
when the filter level is equal to or greater than a fifth threshold which is greater than the fourth threshold, the storage system abandons all packets arriving via the management network.
